(19) United States
(12) Patent Application Publication
(10) Pub. No.: US 2008/0111089 A1
(43) Pub. Date: May 15, 2008

(54) Flow Rate Regulation Valve

(75) Inventor: Masahiro Hasunuma, Saitama (JP)

Correspondence Address: DORSEY & WHITNEY LLP;INTELLECTUAL PROPERTY DEPARTMENT, 250 PARK AVENUE, NEW YORK, NY, 10177, US

(73) Assignee: Surpass Industry Co., Ltd., Saitama (JP)

(21) Appl. No.: 11/720,158

(22) PCT Filed: Oct. 3, 2005
(86) PCT No.: PCT/JP05/18598

§ 371 Date: May 24, 2007

(30) Foreign Application Priority Data
Nov. 25, 2004 (JP) 2004-340426

(51) Int. Cl. F16K 47/00

(52) U.S. Cl. 251/122

(57) ABSTRACT

A flow rate regulation valve (10) comprises a housing (11) formed with an axial hole (14) and a valve hole (13) communicating with the axial hole, a needle valve (60) adapted to move within the axial hole relative to a valve seat located between the axial hole and the valve hole, and a flow rate adjust knob (40) mounted at the proximal end of the needle valve extending from the housing. The needle valve is moved relative to the valve seat by rotating the flow rate adjust knob thereby to regulate the flow rate of the fluid flowing through the valve hole. A first valve body (67) is arranged at the forward end of the needle valve and a second valve body (65) extends from the end surface (67a) of the first valve body. The cross section of the first valve body is larger than that of the second valve body, so that at the time of closing the flow rate regulation valve, the end surface of the first valve body abuts with a valve seat (16) located between the axial hole and the valve hole, and the second valve body is inserted in the valve hole. As a result, fluid can be supplied in a stable fashion with a flow rate that is linearly maintained.

### TECHNICAL FIELD

This invention relates to a flow rate regulation valve for regulating flow rate by moving a needle valve relative to a valve seat.

### BACKGROUND ART

A flow rate regulation valve is now used in various fields. FIG. 6a is a partially enlarged view of a flow rate regulation valve similar to the one disclosed in the prior art, for example, Japanese Unexamined Patent Publication No. 11-230407. As shown in FIG. 6a, the housing 110 of this flow rate regulation valve 100 is formed with an inlet 180 and an outlet 190 communicating with each other through a valve hole 130 and an axial hole 140. As shown, the valve hole 130 is narrower than the axial hole 140. A needle valve 600 is inserted in the axial hole 140, and a substantially conical valve body 650 is arranged at the forward end of the needle valve 600. As shown, the proximal end of the valve body 650 and the forward end of the needle valve 600 coincide with each other. In this flow rate regulation valve 100, the flow rate of fluid flowing through the valve hole 130 can be regulated by moving the needle valve 600 in the opening direction (upward).

FIG. 6b is a diagram showing the relationship between the position of the valve body of the flow rate regulation valve shown in FIG. 6a and the flow rate. In FIG. 6b, the ordinate represents the flow rate Q of fluid flowing through the outlet 190, and the abscissa represents the distance x covered by the valve body 650 in the opening direction from the position thereof in a closed state. Since the valve body 650 of the needle valve 600 is substantially conical, it the needle valve 600 of the flow rate regulation valve 100 in closed state, is moved in the opening direction, as indicated by the solid line Y1 in FIG. 6b, the flow rate Q increases exponentially. Upon movement of the valve body 650 into the axial hole 140 (x=x1), as indicated by solid line Y2, the flow rate Q is kept substantially constant.

In the prior art, a flow rate regulation valve having another form of valve body exists. FIG. 7a is a partially enlarged view of another conventional flow rate regulation valve. In FIG. 7a, a frustconical-shaped valve body 660 smaller in width than the needle valve 600 extends from the forward end of the needle valve 600. When the flow rate regulation valve 100′ is in a closed state, the end surface 665 of the needle valve 600 abuts with the valve seat 160 located between the axial hole 140 and the valve hole 130, so that the valve body 660 is inserted into the valve hole 130.

FIG. 7b is a diagram, similar to FIG. 6b, showing the relationship between the position of the valve body of the flow rate regulation valve shown in FIG. 7a and the flow rate. In this flow rate regulation valve 100′, if the needle valve 600 of the flow rate regulation valve 100′ in a closed state is moved in the opening direction (upward), as indicated by solid line Y3, the flow rate Q rises while keeping the small flow rate linear. Since the gap between the valve hole 130 and the valve body 660 is comparatively small, however, the flow rate Q rises only slightly, and the fluid flows only in a very small amount. Once the forward end 661 of the valve body 660 has entirely moved into the axial hole 140, as indicated by solid line Y4 in FIG. 7b, the flow rate Q remarkably increases from the point at the distance x equal to x2.

Also, since the tapered portion of the valve body 660 widens relatively gradually, a flow rate that is comparatively superior in linearity can be obtained in the area where the distance x is smaller than x2. However, in the case where the flow rate is increased by moving the valve body 660 within the valve hole 130, in such a manner that the valve body 660 remains in the valve hole 130, the gentle taper of the flow rate regulation valve requires a considerably long valve body 660 to obtain the proper flow rate. In such a case, the flow rate regulation valve itself increases in size, and therefore, it is impossible to obtain a comparatively compact flow rate regulation valve.

As described above, in the case where the flow rate regulation valve 100 having the valve body 650 with a sharply spreading tapered portion is used as shown in FIG. 6, it is difficult to regulate the flow rate while keeping the small flow rate area linear at the time of opening/closing. In the case where the flow rate regulation valve 100′ having the valve body 660 with a gently spreading tapered portion is used as shown in FIG. 7, the flow rate regulation range is narrowed and the flow rate is difficult to regulate it is large. In the case where it is desired to widen the flow rate regulation range for the valve body shown in FIG. 7, the tapered portion, i.e. the valve body 660 itself is required to be very long, resulting in an increased size of the flow rate regulation valve.

In recent years, the flow rate regulation valves 100, 100′ have often been used as a regulation valve of the semiconductor fabrication device. In such a case, the instability of the flow rate of a chemical liquid, such as the etching solution or developer adjusted by the flow rate regulation valves 100, 100′ has adversely effected the yield of the semiconductor device to be fabricated. Since demand is high for reduced size semiconductor fabrication device, a compact flow rate regulation valve is also desired. Also, the specification of each flow rate regulation valve is required to have as wide a flow rate range as possible.

This invention has been achieved in view of this situation, and the object thereof is to provide a compact flow rate regulation valve in which a fluid is supplied in a stable fashion at a flow rate in which linearity is maintained from a closed state to a fully open state.

### DISCLOSURE OF THE INVENTION

In order to achieve the object described above, according to a first aspect of the invention, there is provided a flow rate regulation valve comprising a housing formed with an axial hole and a valve hole communicating with the axial hole, a needle valve adapted to move within the axial hole relatively to a valve seat located between the axial hole and the valve hole, and a flow rate adjust knob mounted at the proximal end of the needle valve extending from the housing, wherein the needle valve is moved relative to the valve seat by rotating the flow rate adjust knob thereby regulating the flow rate of the fluid flowing through the valve hole, wherein a first valve body is arranged at the forward end of the needle valve and a second valve body extends from the end surface of the first valve body, and wherein the cross section of the first valve body is larger than the cross section of the second valve body, so that at the time of closing the flow rate regulation valve, the end surface of the first valve body abuts with the valve seat located between the axial hole and the valve hole and the second valve body is inserted in the valve hole.

The flow rate after opening the valve would increase exponentially only if the first valve body is provided so as to abut with the valve seat, while the flow rate after slowly opening the valve would increase only if the second valve body is inserted in the valve hole. In contrast in the first aspect of the invention, the provision of both the first valve body that abuts with the valve seat and the second valve body to be inserted in the valve hole mixes the aforementioned two features in the small flow rate area and flow rate increases substantially linear immediately after opening the valve. The flow rate of the fluid, once increased to a certain level, increases substantially linear in a more stable fashion. Specifically, in the first aspect, the fluid can be supplied in a stable fashion with the flow rate maintaining linear from a closed state to the fully open state.

According to a second aspect of the invention, there is provided a flow rate regulation valve of the first aspect, wherein the first valve body and the second valve body have a frustconical shape extending in the closing direction of the flow rate regulation valve.

According to a third aspect of the invention, there is provided a flow rate regulation valve of the second aspect, wherein the angle between the side surface of the first valve body and the cross section of the needle valve is smaller than the angle between the side surface of the second valve body and the cross section of the needle valve.

Specifically, in the second and third aspects, the first and second valve bodies are such a shape that the flow rate is comparatively smooth from the small flow rate area to the large flow rate area and the difference in the flow rate that changes between the small and large flow rate areas is eliminated. In this way, flow rate is easily regulated by obtaining a flow rate that is linear over the entire range and fluid can be supplied in a stable fashion over the entire range. Incidentally, the first and second valve bodies are preferably in the shape of a truncated cone.

According to a fourth aspect of the invention, there is provided a flow rate regulation valve of any one of the first to third aspects, wherein the first valve body includes a diaphragm mounted on the inner wall of the housing.

Specifically, in the fourth aspect, the fluid can be supplied in a stable fashion with a flow rate that is linearly maintained even for a diaphragm-type needle valve.

All the aspects described above share the advantage that fluid can be supplied in a stable fashion with a flow rate that is linearly maintained from a closed state to a fully open state.

Further, the second and third aspects have an advantage in that the difference in flow rate is eliminated in the boundary between the small and large flow rate areas, and fluid can be supplied in a stable fashion with a flow rate that is linearly maintained.

Furthermore, the fourth aspect has an advantage in that fluid can be supplied in a stable fashion with a flow rate that is linearly maintained even for a diaphragm-type needle valve.

The above and other objects, features and advantages will be made apparent further by the detailed description of typical embodiments of the invention taken in conjunction with the accompanying drawings.

### BRIEF DESCRIPTION OF THE DRAWINGS

FIG. 1a is a front view of a flow rate regulation valve according to this invention.

FIG. 1b is a side sectional view of the flow rate regulation valve according to the invention.

FIG. 2 is a schematic diagram showing an enlarged view of the valve body immediately after the valve is opened.

FIG. 3 is a schematic diagram showing an enlarged view of the valve body.

FIG. 4 is a diagram showing the relation between the position of the valve body and the flow rate in the flow rate regulation valve according to the invention.

FIG. 5 is a front view of the flow rate regulation valve according to another embodiment of the invention.

FIG. 6a is a partially enlarged view of a conventional flow rate regulation valve.

FIG. 6b is a diagram showing the relationship between the position of the valve body and the flow rate in the flow rate regulation valve.

FIG. 7a is a partially enlarged view of another conventional flow rate regulation valve.

FIG. 7b is a diagram showing the relationship between the position of the valve body and the flow rate in the flow rate regulation valve shown in FIG. 7a.

### BEST MODE FOR CARRYING OUT THE INVENTION

The embodiments of the invention are described below with reference to the accompanying drawings. In the drawings, similar component members are designated by the same reference numerals, respectively. To facilitate understanding, the scale of these drawings has been appropriately changed.

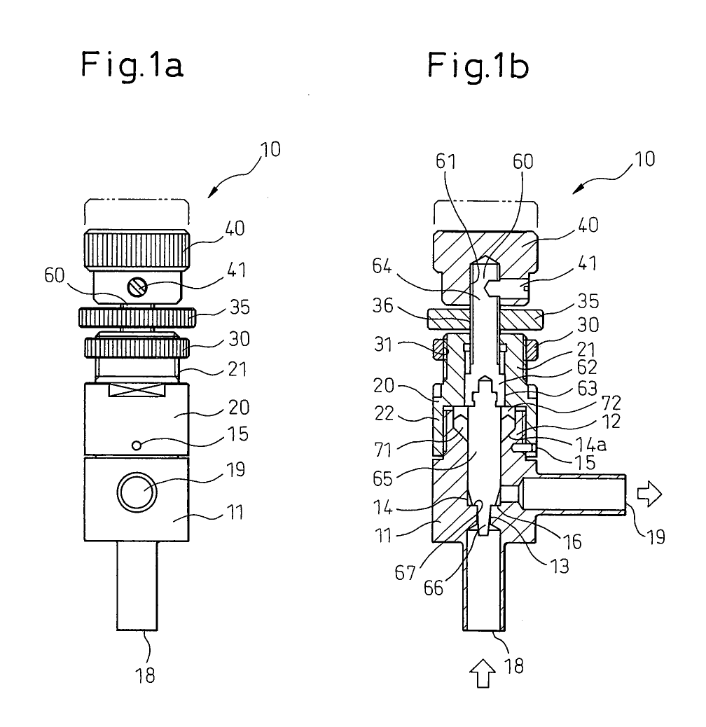

FIG. 1a is a front view of a flow rate regulation valve according to an embodiment of the invention, and FIG. 1b a side sectional view of the flow rate regulation valve according to an embodiment of the invention. As shown in these drawings, the housing of the flow rate regulation valve 10 according to the invention is configured of a lower portion 11 and an upper portion 20. The lower portion 11 of the housing is formed with an inlet 18 and an outlet 19. The inlet 18 and the outlet 19 communicate with each other in the lower portion 11 through a valve hole 13 and an axial hole 14 described later.

As can be seen from FIG. 1b, a lower sleeve 12 that is narrower than the lower portion 11 is arranged in the lower portion 11 of the housing. In the upper portion 20 of the housing, an upper sleeve 22 adapted to engage with the lower sleeve 12 is formed. As shown, the upper portion 20 and the lower portion 11 of the housing are screwed to each other by threads formed on the outer surface of the lower sleeve 12 and the inner surface of the upper sleeve 22, respectively. The upper portion 20 is fixed to the lower portion 11 by a spring roll pin 15 functioning as a fixing pin. A spring roll pin 15, which connects the upper sleeve 22 of the upper portion 20 and the lower sleeve 12 of the lower portion 11 to each other, is normally arranged at a position inaccessible from the outside. Once the lower portion 11 and the upper portion 20 of the housing are assembled, a common axial hole 14 in which the greater part of the needle valve 60 is inserted is formed in the housing. Incidentally, the upper portion 20 and the lower portion 11 may be fixed by other means other than a spring roll pin 15.

According to the embodiment shown in FIGS. 1a, 1b, the upper portion 20 of the housing may function as a seal adjust member for adjusting the sealed state between the upper portion 20 and the needle valve 60. However, the upper portion 20 is normally fixed to the lower portion 11 by the spring roll pin 15 as shown. Specifically, according to an embodiment of the invention, the initial value of the sealed state preset by the manufacturer is maintained, and therefore, even when a user or the like touches the upper portion 20 of the housing, the sealed state between the upper portion 20 and the needle valve 6 remains unchanged. Especially, when mounting the conventional flow rate regulation valve to a panel, the seal nut for determining the sealed state is required to be removed, and therefore, the initial value of the sealed state may be changed. According to this invention, the upper portion 20 functioning as a seal adjust member is not required to be removed at the time of mounting the panel, and therefore, the sealed state remains unchanged.

As shown, a cylindrical extension 21 narrower than the upper portion 20 of the housing extends from the upper portion 20. Further, the needle valve 60 extends from above the extension 21. The outer surface of the extension 21 is formed with a thread to which the extension 21 of the panel nut 30 is screwed. This panel nut 30 is used to fix the flow rate regulation valve 10 to a panel (not shown). Normally, the length of the extension 21 is larger than the sum of the thickness of the panel and the thickness of the panel nut 30.

Further, as shown in FIG. 1b, a flow rate adjust knob 40 is mounted at the proximal end of the needle valve 60. The proximal end of the needle valve 60 is inserted into the hole formed in the flow rate adjust knob 40, and the flow rate adjust knob 40 is fixed to the needle valve 60 by a fixing screw 41. Also, as shown in FIGS. 1a, 1b, a lock nut 35 described later is screwed to the thread 61 between the flow rate adjust knob 40 and the panel nut 30. As shown, the size of the lock nut 35 is larger than the size of the flow rate adjust knob 40 and the panel nut 30. Further, in order for a user to easily grasp each of the flow rate adjust knob 40, lock nut 35 and panel nut 30, the peripheral surfaces of the flow rate adjust knob 40, lock nut 35 and the panel nut 30 are knurled.

Also, as shown in FIG. 1b, the needle valve 60 is configured of a first portion 64 and a second portion 65 including a valve body having a first valve body 67 and a second valve body 66. The first portion 64 has a wide portion 62 to be coupled with the second portion 65, and a thread 63 is formed on the peripheral surface of the wide portion 62. As shown, the thread 63 is screwed into the threaded inner surface of the extension 21 of the upper portion 20. In the presence of these threads, the needle valve 60 can be moved in an axial direction by rotating the flow rate adjust knob 40.

The lower portion 11 of the housing is formed with a narrow valve hole 13 communicating with the inlet 18. As shown, the valve hole 13 and the axial hole 14 are formed concentrically, and the valve hole 13 is narrower than the axial hole 14. Further, as shown, a valve seat 16 is formed between the axial hole 14 and the valve hole 13.

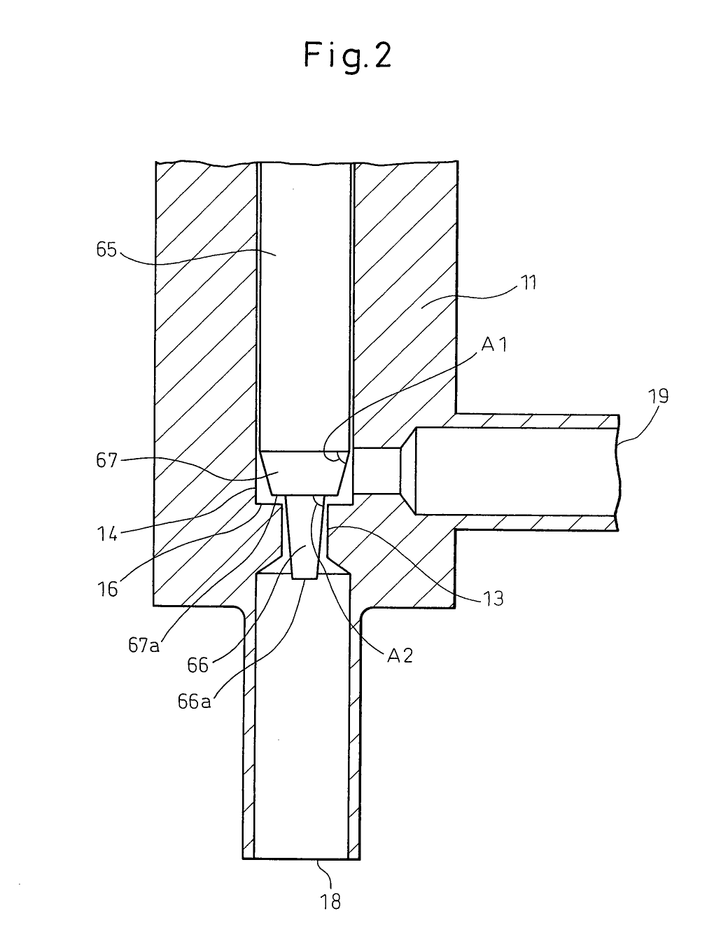

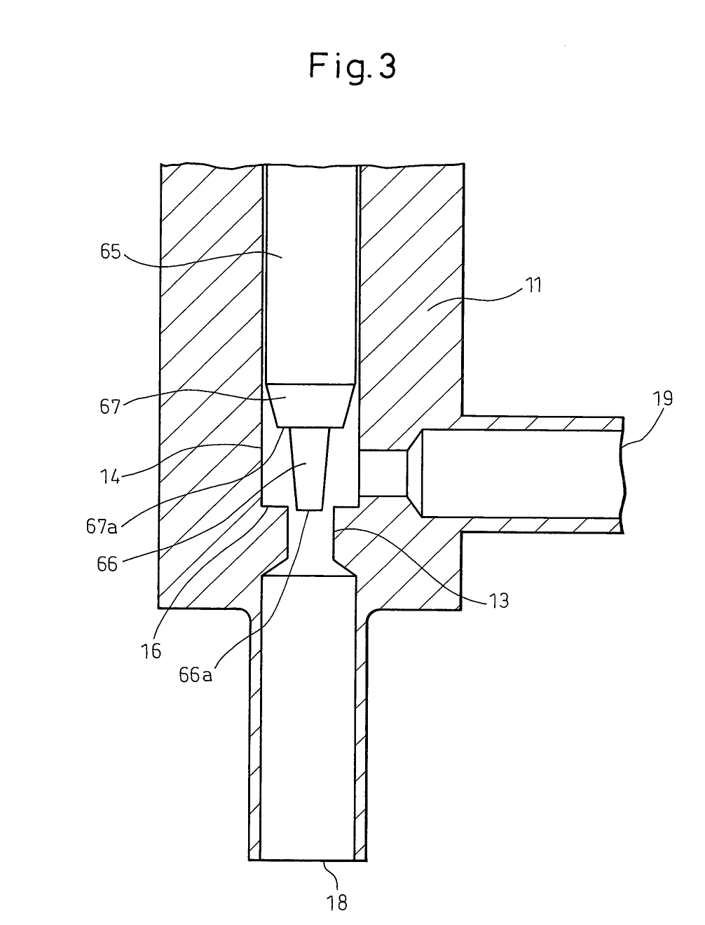

FIG. 2 is a schematic diagram showing an enlarged view of the valve body immediately after the valve is opened. Note that the upper portion 20 of the housing, etc., are not shown in FIG. 2 and FIG. 3 (described later), to simplify the explanation. As shown in FIG. 2, the first valve body 67 is substantially frustconical in shape, and extends in a tapered down fashion in the valve closing direction. The first valve body 67 extends from the end of the second portion 65, and therefore, one end of the first valve body 67 coincides with the end of the second portion 65. Also, the end surface 67a of the first valve body 67 is larger than the sectional area of the valve hole 13.

Further, the frustconical-shaped second valve body 66 extends in a tapered down fashion from the end surface 67a of the first valve body 67 in the valve closing direction. As shown, the second valve body 66 is smaller than the end surface 67a of the first valve body 67. The axial length of the second valve body 66 is longer than the valve hole 13 and the axial length of the first valve body 67. Further, as shown in FIG. 2, the proximal end of the second valve body 66 is slightly smaller than the sectional area of the valve hole 13. Also, according to this invention, the angle A1 between the proximal end of the first valve body 67 and the cross section of the second portion 65 is smaller than the angle A2 between the proximal end of the second valve body 66 and the cross section of the second portion 65.

According to this invention, when the needle valve 60 is fully open, the end surface 66a of the second valve body 66 remains within the valve hole 13 and never moves to the axial hole 14. FIG. 3 is a schematic diagram, similar to FIG. 2, showing an enlarged view of the needle valve 60 fully open. In FIG. 3, the end surface 66a of the second valve body 66 is located slightly lower than the valve seat 16. In the case shown in FIG. 3, fluid flows into the axial hole 14 through the gap between the valve hole 13 and the second valve body 66 and flows out from the outlet 19. Conversely, if end surface 66a of the second valve body 66 moves to the axial hole 14 beyond the valve hole 13, flow rate would increase instantaneously and become uncontrollable. However, according to this invention, when the valve is fully open, the end surface 66a of the second valve body 66 is located within the valve hole 13, and therefore, the flow rate can be controlled.

Referring again to FIGS. 1a, 1b, the flow rate regulation valve 10 is in closed state, and therefore, the end surface 67a of the first valve body 67 of the second portion 65 abuts with the valve seat 16, and the second valve body 66 of the second portion 65 is inserted in the valve hole 13.

Also, in FIG. 1b, a first packing 71 substantially in the frustconical shape is fitted on the slope 14a of the axial hole 14 around the second portion 65 under the wide portion 62. Further, a second packing 72 having a flange extending between the lower portion 11 and the upper portion 20 is arranged above the first packing 71. The first packing 71 and the second packing 72 may be integrated as a single member.

As described above, the lock nut 35 is screwed to the thread 61 of the first portion 64 of the needle valve 60. The lock nut 35 functions to restrict the rotation of the flow rate adjust knob 40. According to the embodiment shown in FIGS. 1a, 1b, the lock nut 35, when located at a position adjacent to the extension 21 of the upper portion 20, fixes the flow rate adjust knob 40 so as to not to rotate. Under this condition, therefore, the flow rate adjust knob 40, even if touched by a user or the like, would not be rotated, and therefore, the flow rate of the flow rate regulation valve 10 remains unchanged. In the case where a gap, which is more than a predetermined size, is formed between the lock nut 35 and the extension 21 by loosening the lock nut 35, the flow rate adjust knob 40 is allowed to rotate, so that the flow rate of the flow rate regulation valve 10 becomes controllable.

When mounting the flow rate regulation valve 10 to a panel (not shown), the flow rate adjust knob 40, the lock nut 35 and the panel nut 30 are removed in that order. Then, the extension 21 of the housing is inserted into the hole of the panel (not shown). The panel hole corresponds to the size of the extension 21, and the panel stops before the upper portion 20. Then, the panel nut 30 is screwed to the extension 21 to fix the flow rate regulation valve 10 to the panel. After that, the lock nut 35 and the flow rate adjust knob 40 are mounted again. As described above, according to an embodiment of this invention, the upper portion 20 of the housing functions as a seal adjust member and is not required to be removed at the time of mounting the flow rate regulation valve 10. Therefore, the sealed state between the needle valve 60 and the housing when shipped can be maintained.

In the operation of the flow rate regulation valve 10 according to an embodiment of the invention, a gap, which is more than a predetermined amount, is formed between the lock nut 35 and the extension 21 of the upper portion 20 by loosening the lock nut 35, after which the needle valve 60 is moved up by rotating the flow rate adjust knob 40. As shown in FIG. 2, immediately after opening the flow rate regulation valve 10, a comparatively small amount of fluid flowing in from the inlet 18 proceeds into the axial hole 14 through the gap between the second valve body 66 and the valve hole 13 and flows out from the outlet 19.

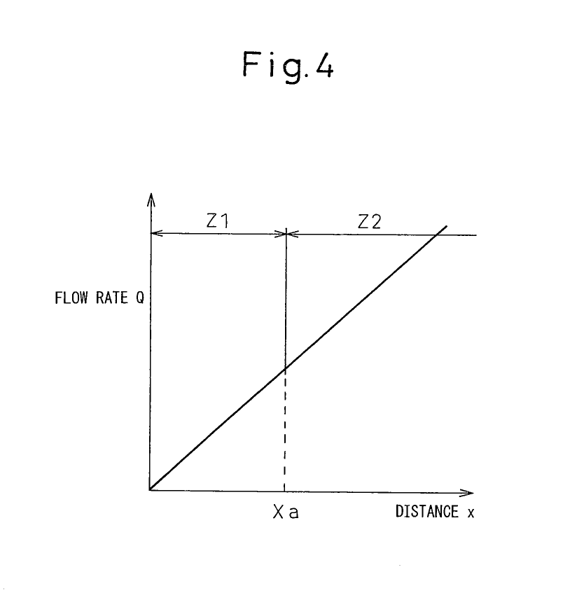

FIG. 4 is a diagram showing the relationship between the position of the valve body and the flow rate in the flow rate regulation valve according to the invention. In FIG. 4, the ordinate represents the flow rate Q of the fluid flowing out from the outlet 19, and the abscissa the distance x between the end surface 67a of the first valve body 67 and the valve seat 16. As described above, at the time of closing the flow rate regulation valve 10, the end surface 67a of the first valve body 67 and the valve seat 16 abut with each other, and therefore, the distance x can be considered equivalent to the distance covered by the needle valve 60 from the closed position to the end of the needle valve in the opening direction.

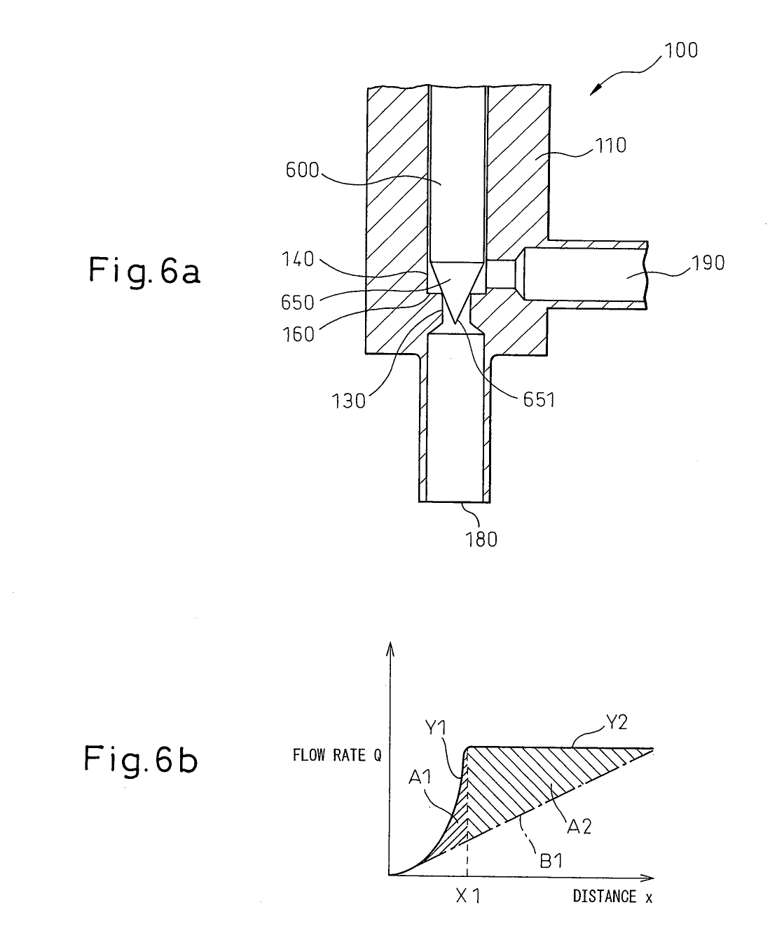

As shown in FIG. 4, the relationship between the distance x covered by the valve body and the flow rate Q is substantially linear in the small flow rate area Z1 where the flow rate after opening the flow rate regulation valve 10 is comparatively small. As shown in FIG. 6 referred to for explaining the prior art, a case in which the needle valve 600 has only a substantially pyramidal valve body 650 may correspond to a case in which the needle valve 60 according to the invention has only the first valve body 67. Assuming that the needle valve 60 according to the invention has only the first valve body 67, the flow rate Q exponentially increases with respect to the distance x in the comparatively small flow rate area described above with reference to FIG. 6.

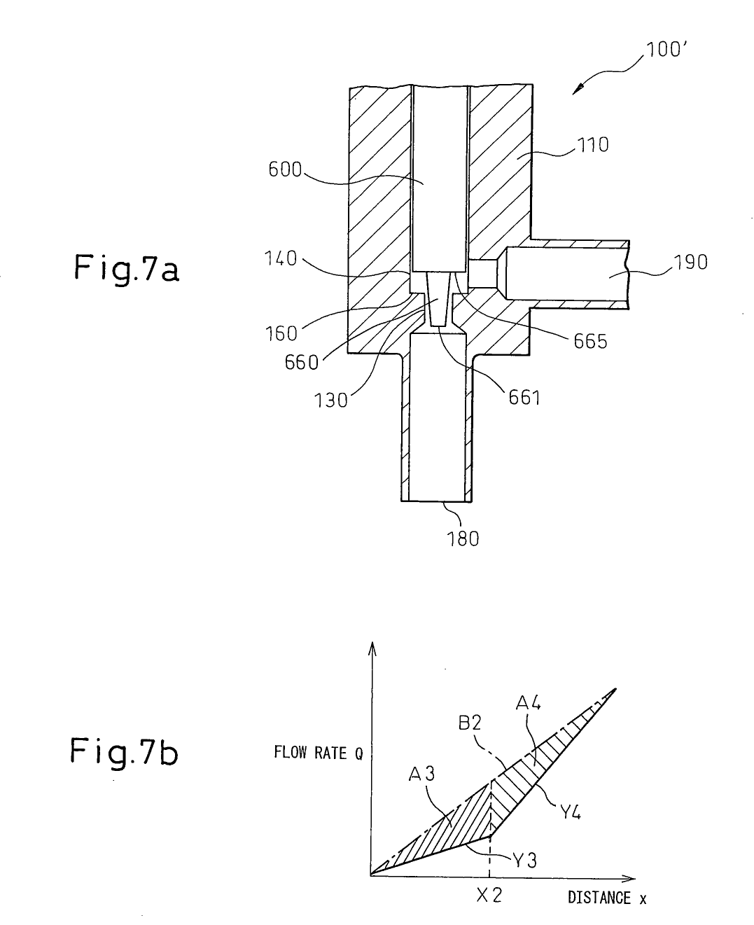

A case in which the needle valve 600 includes only a valve body 660 as shown in FIG. 7, narrower than the valve body 650 referred to for explaining the prior art, on the other hand, may correspond to a case in which the needle valve 60 according to the invention has only the second valve body 66. Assuming that the needle valve 60 according to the invention has only the second valve body 66, therefore, as described above with reference to FIG. 7, the flow rate Q increases comparatively slowly with respect to the distance x in the comparatively small flow rate area. Therefore, it is difficult to secure the required flow rate on the one hand and a large difference or a step in the flow rate change is formed in the boundary (x=x2) (See FIG. 7b) on the other hand.

In contrast, the needle valve 60 according to the invention is comprised of both a first valve body 67 corresponding to the valve body 650 and a second valve body 66 corresponding to the valve body 660. In the small flow rate area Z1 of the flow rate regulation valve 10 according to the invention, therefore, the relationship is a combination of those shown FIG. 6b and in FIG. 7b. In the small flow rate area Z1 according to the invention, a substantially linear relation representing a mixture of the two relationships is obtained (See FIG. 4). Specifically, in FIG. 6b, assuming that the straight line connecting the flow rate at the maximum distance and the origin is a straight line B1, then the area A1 defined by the solid line Y1, the line segment x=x1 and the straight line B1 represents the flow rate excess supplied over the straight line B1. In similar fashion, in FIG. 7b, assuming that the straight line connecting the flow rate at the maximum distance and the origin is a straight line B2, then the area A3 defined by the solid line Y3, the line segment x=x2 and the straight line B2 represents the flow rate shortage below the supply amount indicated by the straight line B2.

Specifically, according to this invention, the area A1 representing the oversupply is supplemented by the area A3 of short supply, so that a substantially linear relationship is obtained between distance x and flow rate Q in the small flow rate area Z1 (See FIG. 4). In this area, therefore, the flow rate changes according to the rotation of the flow rate adjust knob 40. Incidentally, the solid line Y1 in FIG. 6b is a curved line, and therefore, the relationship in the small flow rate area Z1 is not a true straight line. Nevertheless, the substantially linear relationship own in FIG. 4 is obtained.

According to this invention, assuming that the needle valve 60 moves further and the distance x exceeds a predetermined distance xa, the small flow rate area Z1 transfers to the large flow rate area Z2. Also in this large flow rate area Z2, the concept similar to the aforementioned one applies. Specifically, the short supply area A4 defined by the solid line Y4, the line segment x=x2 and the straight line B2 shown in FIG. 7b is supplemented by the oversupply area A2 defined by the solid line Y2, the line segment x=x1 and the straight line B1 shown in FIG. 6b. As shown in FIG. 4, therefore, the linear relationship between the flow rate Q and the distance x also in the large flow rate area Z2 is obtained.

As described above, according to this invention, there is a substantially linear relationship between the flow rate Q and the distance x in both the small flow rate area Z1 and the large flow rate area Z2, i.e. over the entire area, and therefore, fluid can be supplied in a stable fashion with the flow rate maintaining linearity. Thus, even in the case where the flow rate regulation valve 10 according to the invention is used in a semiconductor fabrication device, the yield of the semiconductor devices fabricated is not reduced.

Further, as described above, the first valve body 67 and the second valve body 66 are in the frustconical shape extending in the valve-closing direction. The angle A1 between the proximal end of the first valve body 67 and the cross section of the second portion 65 is smaller than the angle A2 between the proximal end of the second valve body 66 and the cross section of the second portion 65, and the axial length of the first valve body 67 is smaller than the axial length of the second valve body 66. According to the preferred embodiment shown, the angle A1 between the proximal end of the first valve body 67 and the cross section of the second portion 65 is about 80°, and the angle A2 between the proximal end of the second valve body 66 and the cross section of the second portion 65 is about 85°. Further, the axial length of the second valve body 66 is about twice as large as the axial length of the first valve body 67.

The angles A1, A2 and the length of the first valve body 67 and the second valve body 66 are selected in such a manner that the flow rate Q of the flow rate regulation valve 10 when transferring from the small flow rate area Z1 to the large flow rate area Z2 assumes a substantially equal value, i.e. the value Q1 immediately before transfer and the value Q2 immediately after transfer are substantially equal to each other. According to this invention, therefore, the flow rate is transferred from the small flow rate area Z1 to the large flow rate area Z2 comparatively smoothly without causing any step or difference in flow rate change between the small flow rate area Z1 and the large flow rate area Z2. Even in the case where the flow rate at about the boundary (x=xa) between the small flow rate area Z1 and the large flow rate area Z2 is supplied, therefore, the flow rate changes only by an amount corresponding to the rotation of the flow rate adjust knob 40, and therefore, the fluid can be supplied with a stable flow rate.

Although the embodiment shown includes the cylindrical needle valve 60, the frustconical-shaped first valve body 67 and the second valve body 66, the shapes of these cylindrical needle valve 60, the frustconical-shaped first valve body 67 and the second valve body 66 are not limited to those shown in the embodiment. Specifically, the axial hole 14 having a square section, the needle valve 60 having a correspondingly square section, and the first valve body 67 and the second valve body 66 in the shape of a truncated pyramid are also apparently included in the scope of this invention.

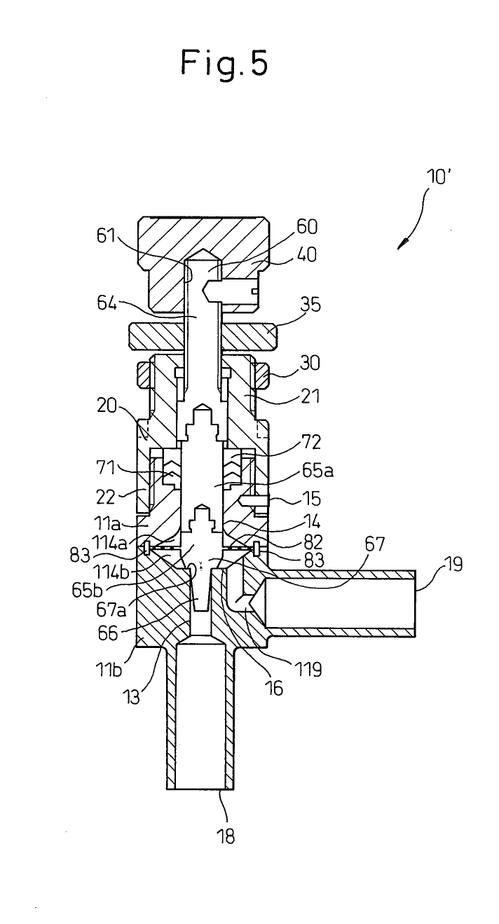

FIG. 5 is a front view of the flow rate regulation valve according to another embodiment of the invention. The same reference numerals described above designate the same component members, respectively, and therefore, the component members already explained are not explained again. The lower portion 11 of the housing of the flow rate regulation valve 10′ shown in FIG. 5 includes a portion 11a screwed to the upper portion 20 and a portion 11b formed with the inlet 18 and the outlet 19. The portion 11a is formed with an upper chamber 114a, and the portion 11b with a lower chamber 114b. The upper and lower chambers 114a, 114b are each formed with the valve hole 13 and the axial hole 14 concentrically, and have a larger section than the axial hole 14. The portion 11b is formed with a path 119 for establishing communication between the lower chamber 114b and the outlet 19.

Further, the second portion 65 of the needle valve 60 includes an upper portion 65a coupled to the first portion 64 and a lower portion 65b having the first valve body 67 and the second valve body 66. The upper portion 65a and the lower portion 65b are coupled to each other in the same way as the first portion 64 and the second portion 65 explained above with reference to FIG. 1 are coupled to each other. Incidentally, the upper portion 65a and the lower portion 65b may be coupled to each other by other methods, or may be formed integrally with each other.

Further, as shown in FIG. 5, the body of the lower portion 65b has a diaphragm 82. The edge 83 of the diaphragm 82 is arranged in a depression formed in the portion 11a and the portion 11b, so that the diaphragm 82 is supported between the upper chamber 114a of the portion 11a and the lower chamber 114b of the portion 11b. The diaphragm 82 itself is hermetic, and therefore, the upper chamber 114a and the lower chamber 114b are sealably separated from each other by the diaphragm 82. Further, the second valve body 66 extends in axial direction from the end surface 67a of the first valve body 67. The first valve body 67 and the second valve body 66 are similarly shaped to those described above. The first valve body 67 and the second valve body 66 may be formed integrally with the diaphragm 82.

In the case where the needle valve 60 is moved in an axial direction when the flow rate regulation valve 10′ is in operation, fluid flows into the lower chamber 114b under the diaphragm 82 through the gap between the second valve body 66 and the valve hole 13, and then, flows out from the outlet 19 through the path 119. The diaphragm 82 shown prevents the fluid flowing in through the inlet 18 from flowing between the upper portion 65a and the axial hole 14, while at the same time making possible the fine adjustment of the flow rate. Also in this embodiment having the diaphragm 82 coupled with the first valve body 67 and the second valve body 66, like in the embodiment described above, the fluid can be apparently supplied in stable fashion with the flow rate maintaining the linearity from the closed state to the full open state. Further, though not shown in the drawings, what is called the device of air-operated type in which a part of the needle valve 60 having the diaphragm 82 is inserted into a spring is included in the scope of this invention.

This invention is explained above with reference to typical embodiments thereof, and those skilled in the art will understand that the aforementioned changes and various other modifications, omission and addition can be made without departing from the scope and spirit of the invention.

### DESCRIPTION OF REFERENCE NUMERALS

10 Flow rate regulation valve
11 Lower portion
13 Valve hole
14 Axial hole
14a Slope
15 Spring roll pin
16 Valve seat
18 Inlet
19 Outlet
20 Upper portion
30 Panel nut
35 Lock nut
40 Flow rate adjust knob
60 Needle valve
62 Wide portion
64 First portion
65 Second portion
66 Second valve body
67 First valve body
71 First packing
72 Second packing
A1, A2 Angle
Z1 Small flow rate area
Z2 Large flow rate area

1. A flow rate regulation valve comprising:
a housing formed with an axial hole and a valve hole communicating with the axial hole;
a needle valve adapted to move within the axial hole relatively to a valve seat located between the axial hole and the valve hole; and
a flow rate adjust knob mounted at the proximal end of the needle valve extending from the housing;
wherein the needle valve is moved relatively to the valve seat by rotating the flow rate adjust knob thereby to regulate the flow rate of the fluid flowing through the valve hole;
wherein a first valve body is arranged at the forward end of the needle valve and a second valve body extends from the end surface of the first valve body, and the cross section of the first valve body is larger than the cross section of the second valve body; and
wherein at the time of closing the flow rate regulation valve, the end surface of the first valve body abuts with the valve seat located between the axial hole and the valve hole, and the second valve body is inserted in the valve hole.

2. The flow rate regulation valve according to claim 1,
wherein the first valve body and the second valve body are in the frustconical shape extending in the closing direction of the flow rate regulation valve.

3. The flow rate regulation valve according to claim 2,
wherein the angle between the side surface of the first valve body and the cross section of the needle valve is smaller than the angle between the side surface of the second valve body and the cross section of the needle valve.

4. The flow rate regulation valve according to any one of claims 1 to 3,
wherein the first valve body includes a diaphragm mounted to the inner wall of the housing.
